(19) United States
(12) Patent Application Publication
(10) Pub. No.: US 2014/0279653 A1
(43) Pub. Date: Sep. 18, 2014

(54) LOGISTICS SECURITY AUTHENTICATION INTEGRATED SYSTEM

(71) Applicants: Rogerio PUCCA DIAS, Aracoiaba da Serra-Sao Paulo (BR); Domingos Pedro MORCILLO MORENO, Aracoiaba da Serra-Sao Paulo (BR)

(72) Inventors: Rogerio PUCCA DIAS, Aracoiaba da Serra-Sao Paulo (BR); Domingos Pedro MORCILLO MORENO, Aracoiaba da Serra-Sao Paulo (BR)

(21) Appl. No.: 13/842,276

(22) Filed: Mar. 15, 2013

(51) Int. Cl. G06Q 10/08

(52) U.S. Cl. CPC G06Q 10/0833
USPC 705/333

(57) ABSTRACT

LOGISTICS SECURITY AUTHENTICATION INTEGRATED SYSTEM relates to an invention to generate identifiable information, including identification information of the operation inherent to a purchase or transaction with pre-determined image data that the system provides and records what corresponds to a secure operation between the negotiating parties; it adds music, lights, logos and reveals the personal image aiming to disseminate through marketing or advertising, which hampers the act of circumventing the system; includes the sending of e-mail addresses and links that allow access to the system in which the database makes available footage or photos sent by e-mail or other means to the product buyer, or being viewed on their own sales site. In real time or not, the buyer is even able to contest the images before or after delivery of the product, through the means of the system, and the user can also download a copy of the file on his/her computer.

### SUMMARY OF THE INVENTION

The present invention relates to a new LOGISTICS SECURITY AUTHENTICATION INTEGRATED SYSTEM, particularly to a system where the user, when making a purchase, electronically holds a site administrator access to the system. This system communicates with a distributor of coupons and communicates in parallel with a real-time web site imaging storing device for tracking the product purchased from the transportation logistics phase from the supplier to the final reception of the product by the consumer.

### BACKGROUND OF THE RELATED ART

In the current state of the art, purchases and transactions on the Internet are known as e-commerce. This type of business transaction is carried out especially through electronic equipment such as computer, phone, and television.

Electronic commerce is the most modern and simple sales channel. It does not involve heavy investment of resources or staff and also can be accessed by the today's more widespread electronic means, the Internet. Electronic commerce is a global trend due to the fact that the Internet is a tool without territorial boundaries that allows any user in front of their computer or any other device to have access to websites located anywhere in the world.

A big problem with e-commerce is in the traceability of the request. In the current system, the buyers receive a protocol with an identifier password that allows them to locate the purchase status. This information is updated by vendors seeking to provide greater security to the buyer, which are limited to tracking and security.

Given the problems with the current state of the art, the applicants have developed an integrated solution with a LOGISTICS SECURITY AUTHENTICATION INTEGRATED SYSTEM, which is characterized by generating identifying information, including operation identification information inherent to a purchase or transaction, with predetermined image data that the system provides and stores corresponding to a safe operation between the negotiating parties.

In the present invention, the proposed system, in a further embodiment, adds music, lights, logos and reveals the personal image aiming to disseminate through marketing or advertising, which hampers the act of circumventing the system. One step includes sending links and e-mail addresses that allow access to the system in which its database makes available footage or photos forwarded by e-mail or other means to the product buyer, or being viewed on their own sales site.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an illustrative diagram of the system.

### DETAILED DESCRIPTION OF THE INVENTION

In a preferred embodiment, the system involves a site with a layout, system logo, etc. Thus, the system object of the present invention has a customized feature that can be acquired in parts or as a complete package.

The system includes software that generates tickets, bar codes or requests to third party companies for their operational functionality and allows the use of various equipment which exists on the market for users to make footage and photos of their products.

The software operates according to a flow chart. It generates tickets, bar codes, or requests to third party companies. Through an access link to the system from third party companies, this being one of the communication gates, the software first performs the request of code lots automatically (1). As the lot is ready, it is stored, such as in an electronic magnetic means, already received. The system then await the orders to be made (2), after requested orders, and then the system proceeds the dispatch thereof (3) to the addressee (4).

At the time of filming and/or taking photos, or upon delivery in the mail or carrier, the system and/or a third party will incorporate a virtual map for location coordinates and/or vehicle searcher that interacts with the site through already existing shipping companies that use this tracking system and makes them available to users, from beginning to the end of the delivery (end-to-end), including date and time in order to provide more security to the system and improved monitoring. The invention has applications in several segments and most businesses, including industrial, road, airport, port institutions, and the like.

It has a map including the execution of a GPS-type application where a cursor shall indicate positioning of cargo. This occurs on the preferred embodiment which first executes the function (identification, database access, publication, etc.). At the time of the product delivery to the carrier, the carrier's system (1) proceeds to the dispatch thereof by an access link to the website system (2), and it forwards this access link for product location to the requester (3) through e-mail or may be seen directly within the website control panels (4), to have access to the progress of the order.

The system includes a virtual map that operates so as to continuously track the movement in real time. The maps of the order progress can be sent by e-mail or via links through access to the system so that the product shipping and location can be seen in real time.

Upon delivery of the product, there is a possibility that the delivery man sends a SMS message or e-mail reporting to the system as warranty and security of the service performed. The information is digitalized, processed, and sent with the software execution performing the following functions: Upon delivery of the merchandise, through control panels of portable computers or phones as an option, information can be entered into the system (1). Such entry can be in the following sequence. Fields are open in the control panel to click in an icon regarding the product codes, positioning or typing them (2), and further informs that the product was delivered or not, whereafter the systems writes it off. It is then finished (3) or not finished (4) if there is an unforeseen event. So that it may be concluded as being received, the system requests the receipt by the receiver which shall also enter in the system and make the same as the deliverer, using its control panel executing the command (3).

In an optional variant, the system has the application field aimed at insurance companies, generating proofs and evidences, time reduction and cost generally, if there are incidents. The system (1) provides access to the use of recording peripheral equipment (recording camera) so that at the time the product is delivered or after delivery, a conference and analysis can be made between the involved parties. Access to introduce information data is provided, if there is a possible violation or occurrence. The system has for both parties, a recording copy of the product and previous tracking, a field remains open for new proof data, if needed, in the system control panels (2), with individual access to the parties involved. With all these contents, the system further passes this data onto the insurance company (3).

The system can be implemented with the QR CODE technology to provide more possibilities to customer information and controlling.

A preview icon of the electronic map corresponding to the order can be viewed as packaging, often used simple circular spot, product photo and image of the transportation means used in the control software belonging to itself or third party. It is an application for (1) accessing a database (2) and for sending a monitoring signal verifying the positioning and returns an identification signal, as seen by a monitor (3).

The system allows the user to submit their ticket codes to be authorized, eliminating the possibility of duplication or using only the authorized system code.

Several security devices are placed internally or externally with the product in order to know the exact moment when the package is opened, so there is not time enough to try to beat the system.

Another option is that the system has access to Skype or similar technology used for the precise moment of opening the product packaging.

It is part of the inventive scope that the system has a set of operations, steps, and components to the preferred embodiment of the invention.

A set of forms, which are filled in and sent (1) to a database (2) recording and generating an authorization password (3), can be sent to the website. The images, footages and/or photos regarding the product, are received and the buyer can evaluate the footage including even before the purchase was carried out. The buyer then has legal proof after the product purchase, if needed, since the buyer has possession of such images.

The remittance of images and information is made through the control panel (1) where there are specific fields for information typing and fields to attach images stored in computers. Alternatively icons can be used instead of typing. After this, the system (2) receives the data of this last sequence of data remittance, also known as Upload.

The receipt of images is made through the control panel (1) where the system received information for orders of exposed fields, through the selection of listed images, in conjunction with the related product code exposed in specific locations. The system receives the order message of images (2) and sends them to the destination computer (3), at this time it is made the Download.

Arranged in several parts of the website are locations with search fields which may or may not be random. The user may find images, vendors, related products, quantity, etc., typing in an open field, or selecting on the drop down menus regarding the search.

The product can come filmed from the manufacturers, at the time of its production, or in the act of packaging and also during repackaging by third parties, shops, etc. The recording occurs with a device that shoots uncut from the beginning to the end of filming until the closing of the pack, with their seals and tickets, used to close the product to complete the filming (1). It is sent to the computers storage locations for data transmission cables, Bluetooth, etc. (2) which are subsequently sent to the system by Upload (3).

The seller purchase numbered tickets from the system exposed on the site, purchase made by the e-commerce system. For example, they may be physical or virtual. These are inviolable adhesive stickers through denting or seals of the inviolable self-sticker only type. In other words, tamper proof seals or stickers can be used. After the purchase of a lot, the system sends it to the buyer who receives by the post the seals to close his products.

The virtual system runs software that does the following procedure: after the purchase of a numbered lot, the seller receives it via download, or e-mail, for example, through the site, when he will print the numbers through his customized personal seals.

The images generated by the product vendor and product for each ticket attached to it, are sent to the site and stored in the system. By opening the field to send images via a control panel, it provides an option of selection of images for submission (1), contained in the local computer after it is attached and sent to the system (2) by clicking on the icon to send content, known as Upload. Therefore, for each image uploaded to the system, it requests a new code and filming for safety reasons.

The new code is generated by comparison of codes, without equal codes, duplicate or previously used by the same user or others, active or not (1), i.e. surveyed by software (2), so that the sending of the image is not blocked.

The system blocks any irregularity manually or automatically.

As for the buyer who views the image of the seller's product already on the system. The storage is made in magnetic high security electronic tapes (1), sent via the internet (2). The site uses all available resources for this purpose, such as the use of web hosting services, tools, etc.

At the time the product image is being displayed, the system hides it from other buyers, with a warning to wait, and if the product is sold, this picture is removed permanently from the view of others. The picture is thereby left visible only to the buyer and seller, for a period determined by the system. Recalling that the buyer must purchase the product at a site and time determined by the seller, so as not to prevent others from buying the product if a sale is not negotiated.

After the sale, the vendor interacts with the system by unplugging it from the system or requesting the permanent withdrawal of the film, but the system always keeps a copy for a certain period of time. The system eliminates image files. The system eliminates the preview copy, demagnetizing data, deleting, (1) if the seller does not remove or makes the request, and (2) the system has a proper predetermined time to delete this file automatically if the request is not made by the seller.

The system stores the records in a database with references. Upon receiving the dispatched recordings (1) with the product code depending on the data subscription of users, the system stores it in high security magnetic media (2), in chronological order of transmission (3), and, as a backup, in sequential order with the ticket numbers. (4)

Alert and warning icons or directions are placed on the buyer and seller site regarding the various procedures that the system provides. FIG. 1 shows the diagram of the present invention in a preferred embodiment where the block (1) displays the product with reference to the ticket's code. The Block (2) with the product being displayed with the recording ticket and can expect a possible release, heading for the next filming of the same item if there is an icon (4). The Block (3) shoots the unsold product, released for viewing. The Block (4) provides the remaining amount of “X” film of the same product. Whereas the block (5) shoots the product already sold, go to the next one.

It is noted from what has been described and illustrated that the “LOGISTICS SECURITY AUTHENTICATION INTEGRATED SYSTEM”, now claimed comply with the rules governing the patent in light of the Industrial Property Law regarding the foregoing and as a consequence, therefore deserving its respective privilege.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1-12. (canceled)

13. A system for integrated logistics security authentication, the system comprising:
a system that generates tickets, bar codes or requests to third parties, for their operational functionality and allows a user to make one of footage, photos or a combination thereof of their product;
a flowchart that generate tickets, bar codes or requests to third parties;
a link to the third party's system, which is a communication gate that executes the first batch of codes requested automatically;
the system stores on electronic magnetic media information received through the communication gate, whereafter the system waits for requests to be made;
after the requests are ordered, the system triggers sending of a map to the recipient, the map includes the implementation of a UPS-like application where a cursor points out the positioning of the load;
upon delivery of the product to a carrier, a system of the carrier triggers sending of a link for access to the system's site, and the link is redirected to access the location of the product to the requester, the link is sent via e-mail or is viewed directly within the site's control panels, whereby access to the movements of the product is provided.

14. The system for integrated logistics security authentication according to claim 13, further comprising a virtual map, the map operates to continuously track movement in real time of the product, progress of the product can be sent by e-mail or by links through access to the system to see real time shipping and product location, a time of delivery of the product is a optionally show by a delivery person sending a SMS or e-mail report to the system as warranty and safety delivery, such information is digitized, processed and shipped to the system where performs the following functions: time of delivery of goods is optionally available for laptops or cell phones, an) entry the system remains open on a control panel to click on the icon for product codes, positions or type of product,
an announcement is subsequently made of whether or not the product has been delivered, if delivered, the system indicates that delivery is completed and if not completed for any unforeseen circumstances, such an announcement is available;
when the product is received, the system prompts a receipt to a receiving party, the receiving party enters the system using their panel control triggering a command.

15. The system for integrated logistics security authentication according to claim 13, wherein the system gives access to the use of peripheral recording equipment, such as a movie camera, so that upon delivery of the product or after delivery is made, one conference and analysis can be done between parties, providing access to enter information data if a possible violation occurs; the system provides to both a copy of the recording of the product and previous tracking, and a field remains open for evidence of new data if necessary, in control panels of the system with access to individual parties.

16. The system for integrated logistics security authentication according to claim 13, wherein the system is implemented with QR CODE technology to give more possibilities of control and information to a customer.

17. The system for integrated logistics security authentication according to claim 13, wherein an icon of an electronic map is displayed which corresponds to the order, the icon can enable viewing of packaging of the product, simple circular point already commonly used, product photo and an image of transport used from control software of third party or control software of the system, an application that accesses a database and sends a monitoring signal that checks the positioning and returns an identification signal is seen by a screen.

18. The system for integrated logistics security authentication according to claim 13, wherein the system allows the users to submit tickets codes to be authorized, eliminating the possibility of duplicates or using only an authorized system code.

19. The system for integrated logistics security authentication according to claim 13, further comprising a set of forms that are filled out and submitted to a database that records and generates an authorization password, the passwords enable a user to use the site to send and receive pictures, footage and photos of the product, and the buyer can evaluate a film even before the time of purchase whereby the buyer has legal evidence after purchasing about the product images.

20. The system for integrated logistics security authentication according to claim 13, wherein sending pictures and information is done through a control panel where there are specific fields for typing information and related fields to attach images stored on computers, through actions of commanding over the icons, whereafter the system receives the data of a latter sequence data transmission which is known as Upload.

21. The system for integrated logistics security authentication according to claim 13, wherein receiving of images is done through a control panel where the system receives order information in the exposed fields through selections of images listed, together with the related product code exposed in specific locations, the system receives the images request and sends them to the target computer where the images can be Downloaded.

22. The system for integrated logistics security authentication according to claim 13, wherein product images generated by the seller for each product and information about a ticket attached to the product are sent to the site and stored in the system, a field for sending images is open via a control panel, option of selection of images for submission is provided, contained in the local computer after it is attached and sent to the system by clicking on the content sent, known as Upload, storage and made in electronic magnetic high security media, sent via internet, the site uses all available resources for this purpose, such as the services of hosting sites and tools.

23. The system for integrated logistics security authentication according to claim 13, wherein block (1) views the product with the related ticket code; block (2) with the product being displayed for the recording ticket and can expect a possible release, heading for the next recording of the same item if there is an icon (4), block (3) records the unsold product, released for viewing; block (4) provides the remaining amount of “X” film of the same product, and block (5) records the product sold, go to the next one.
